(19) United States
(12) Patent Application Publication
(10) Pub. No.: US 2004/0037980 A1
(43) Pub. Date: Feb. 26, 2004

(54) Insulated beverage or food container stock

(75) Inventor: John Charles DeBraal, Appleton, WI (US)

Correspondence Address: APPLETON PAPERS INC., LAW DEPARTMENT, 1400 N. RANKIN STREET, PO BOX 359, APPLETON, WI, 54912-0359, US

(73) Assignee: Appleton Papers Inc., Appleton Papers, WI (US)

(21) Appl. No.: 10/645,486

(22) Filed: Aug. 22, 2003

Related U.S. Application Data
(63) Continuation-in-part of application No. 10/167,463, filed on Jun. 13, 2002.
(60) Provisional application No. 60/298,386, filed on Jun. 18, 2001.

(51) Int. Cl. D21J 1/00; B29D 22/00; B32B 1/08; B32B 9/00; B65D 5/56

(52) U.S. Cl. 428/34.2; 428/318.4; 428/319.3; 428/319.7; 229/5.84

(57) ABSTRACT

A method of producing an improved insulated container stock, such as a cup is disclosed comprising the steps of providing a sheet of polymeric foam having a first surface and second surface; providing a paper sheet suitable for cup stock; extruding a molten polyethylene polymer or copolymer into a molten sheet of film directed between the paper sheet and a first surface of the foam sheet to form a three layer laminate of foam, film, and paper; directing the three layer laminate into a nip having a preset gap; pressing the layers of the three layer laminate entering the nip into adherent contact as the molten film solidifies to form a laminate of substantially uniform caliper exiting the nip; extruding a molten polymer, preferably a heat shrinkable polymer, as a fourth layer forming a molten sheet of film directed onto a second surface of the foam of the three layer laminate to form a four layer laminate of polyethylene film, foam, polyethylene film and paper; directing the four layer laminate into an additional nip having a preset gap; pressing the layers of the four layer laminate entering the nip into adherent contact as the molten polymer, preferably heat shrinkable polymer, solidifies; forming the four layer laminate into a container wall for surrounding an interior space, adding a bottom portion to form a cup, and optionally heat treating the formed cup to shrink the fourth layer of the four layer laminate.

This application claims benefit of commonly assigned U.S. Ser. No. 10/167,463 “Insulated Beverage or Food Container” filed Jun. 13, 2002 the entire contents of which are incorporated herein by reference; and claims benefit of commonly assigned U.S. Ser. No. 09/923,332 “Insulated Beverage or Food Container” filed Aug. 8, 2001, the entire contents of which are incorporated herein by reference and U.S. Serial No. 60/298,386 filed Jun. 18, 2001, the entire contents of which are incorporated herein by reference.

### FIELD OF THE INVENTION

The present invention relates to an apparatus and method for forming insulated container stock. In particular the present invention relates to an insulated, paper-based beverage or food container or sleeve having improved insulation properties, having moisture barrier properties and a method of producing these insulated containers or container stock.

### DESCRIPTION OF RELATED ART

Current standard paper cup stock permits excessive heat transfer through the wall of an insulated beverage container. A user's hand can become uncomfortably hot when excessive heat transfer is permitted through the container wall. This may require the user to be inconvenienced by having to release the container due to the excessive heat of the container's contents. Thus, such containers have a low hold time.

DeBraal et al., published application 20030021921 (provisional application No. 60/298,386 filed Jun. 18, 2001) discloses an insulated container stock of paper, a foam layer along an interior surface and a polymer shrink film.

Van Handel U.S. Pat. No. 6,536,657 discloses a disposable paper cup with side wall overlayed with a pattern adhered shrink film adhered along a plurality of seal lines.

Neale U.S. Pat. No. 6,265,040 discloses a sleeve formed of a thermally insulated coating comprised of binder and expandable void containing particles. A heat activated adhesive bonds the sleeve to the cup.

Ioka U.S. Pat. No. 4,435,344 discloses a paper container coated or laminated on one or both sides with a thermoplastic resin film that is foamed by heating relying on moisture in the paper to provide a foaming agent to expand the resin film into a foam.

Esokov U.S. Pat. No. 3,930,917 discloses a polystyrene foam which is laminated with paper, sheet plastic material, or canvas by remelting the polystyrene foam in a heated nip.

However the inventor has determined that the materials and methods of the related art suffer from at least the following disadvantages: Laminates are costly to manufacture limiting commercial acceptability particularly in applications that are highly price competitive. Three and four layer laminates have not gained commercial acceptability due to high cost of manufacture. Many prior art methods rely on a solid film formation step or use solid preformed or blown films.

The prior art has not achieved methods of manufacturing cost effective multi-layer insulated stock that effectively impedes heat transfer between the container contents and the exterior.

### BRIEF SUMMARY OF THE INVENTION

The present invention overcomes shortcomings associated with conventional devices and methods, and achieves advantages not realized by conventional devices, methods or materials.

It is an aspect of the present invention to provide a method of producing a three layer, or four layer laminate, useful as an insulating material for beverages, food containers or sleeves.

It is an aspect of the present invention to provide an improved method of manufacturing a three layer or four layer insulating laminate useful as cup stock, food container stock, or sleeve stock.

The method of the invention eliminates having to manufacture a laminate from a preformed solid film. The solid film production step is eliminated providing more control, polymer choice, opportunity to add additives and not limited to films commercially available. The process of the invention reduces cost of manufacture and increases the choice of polymer combinations available to form laminates suitable as food or beverage stock, including cup stock, food container stock or sleeve stock such as cup sleeve stock.

In an embodiment of the invention a method of producing an insulated container stock is taught comprising the steps of providing a layer of polymeric foam having a first surface and second surface; providing a paper stock layer suitable for food or beverage stock; extruding a molten polyolefin forming a molten sheet of film directed between the paper stock layer and a first surface of the foam layer to form an at least three layer laminate of foam, polyolefin film, and paper; directing the at least three layer laminate into a nip having a preset gap; and pressing the layers of the at least three-layer laminate entering the nip into adherent contact as the molten film solidifies to form a laminate of substantially uniform caliper exiting the nip.

In a further embodiment the method comprises the additional steps of forming the at least three layer laminate into a container wall for surrounding an interior space, and adding a bottom portion to form a cup. If the bottom portion is omitted, such that the container wall surrounds an interior space, the resultant object will be either a cup sleeve suitable for holding a beverage cup, or alternatively a conical shape which does not require a separate bottom portion. Frozen products are commonly dispersed using conical shaped containers.

In yet another embodiment the method of producing an insulated container stock comprises the additional steps of extruding a molten polymer, preferably a shrinkable polymer, as a fourth layer forming a molten sheet of film directed onto a second surface of the foam of the at least three layer laminate to form an at least four layer laminate of film, foam, polyolefin film and paper; directing the at least four layer laminate into an additional nip having a preset gap; and pressing the layers of the at least four layer laminate entering the nip into adherent contact as the film solidifies. The nips can be formed from a pair of opposing rollers, a slot die, a roller and opposing block by way of illustration and not limitation. Optionally, the nip can be chilled by chilling any of the rollers or blocks.

In yet another embodiment, the method of producing an insulated container stock comprises the additional steps of forming the four layer laminate into a container wall for surrounding an interior space, and adding a bottom portion to form a cup.

In yet another embodiment, the method of producing an insulated container stock, comprises the steps of providing a layer of polymeric foam having a first surface and second surface; providing a paper stock layer suitable for cup stock; extruding a molten low density polyethylene polymer or copolymer forming a molten sheet of film directed between the paper sheet and a first surface of the foam layer to form a three layer laminate of foam, polyethylene film, and paper; directing the three layer laminate into a nip having a preset gap; pressing the layers of the three layer laminate entering the nip into adherent contact as the molten polyethylene film solidifiers to form a laminate of substantially uniform caliper exiting the nip; extruding a shrinkable polymer as a fourth layer to form a molten layer of shrinkable film directed onto a second surface of the foam of the three layer laminate to form a four layer laminate of shrinkable film, foam, polyethylene film and paper; directing the four layer laminate into an additional nip having a preset gap; pressing the layers of the four layer laminate entering the nip into adherent contact as the shrinkable film solidifies; and forming the four layer laminate into a container wall for surrounding an interior space, and adding a bottom portion to form a cup.

In yet another embodiment, the method of producing an insulated container stock, comprises the steps of providing a layer of polymeric foam having a first surface and second surface; providing a paper stock layer suitable for cup stock extruding a molten low density polyethylene polymer or copolymer into a molten sheet of film directed between the paper stock layer and a first surface of the foam layer to form a three layer laminate of foam, polyethylene film, and paper; directing the three layer laminate into a nip having a preset gap; pressing the layers of the three layer laminate entering the nip into adherent contact as the molten polyethylene film solidifiers to form a laminate of substantially uniform caliper exiting the nip; extruding a molten heat shrinkable polymer as a fourth layer forming a molten sheet of shrinkable film directed onto a second surface of the foam of the three layer laminate to form a four layer laminate of shrinkable film, foam, polyethylene film and paper; directing the four layer laminate into an additional nip having a preset gap; pressing the layers of the four layer laminate entering the nip into adherent contact as the shrinkable film solidifies; forming the four layer laminate into a container wall for surrounding an interior space; and adding a bottom portion engaging the container wall along a lower side portion thereof to form a cup, and, heat treating the formed cup to shrink the fourth layer of the four layer laminate.

### BRIEF DESCRIPTION OF THE DRAWINGS

The present invention will become more fully understood from the detailed description given hereinafter and the accompanying drawings which are given by way of illustration, and thus are not limitative of the present invention, and wherein:

FIG. 1 is a cross-section view of a method of forming a three layer laminate of the invention.

FIG. 2 depicts a three layer laminate cross-section shown before evening out of caliper variation.

FIG. 3 illustrates a three layer laminate after processing through a nip having a preset gap to even out caliper variation.

FIG. 4 is a cross-section of a four layer laminate according to the invention.

FIG. 5 is a cross-section view of a method of forming a four layer laminate of the invention.

FIG. 6 is a cup or sleeve whose sidewall comprises a four layer laminate.

### DETAILED DESCRIPTION

The present invention is directed to an improved insulated container stock, methods for forming the improved insulated container stock, and cups, food and beverage containers and sleeves made from such improved insulated container stock.

The present invention is a method of producing an insulated container stock. The method comprises the steps of providing a sheet of a polymeric foam. The sheet has a first surface and an opposing second surface. There is also provided a paper sheet, selected to be suitable as cup stock. This paper sheet is typically of from 10 to 40 mils in thickness, and more particularly from 10 mils to 26 mils in the thickness in a preferred embodiment of the invention.

A polyolefin, preferably low density polyethylene polymer (PE) or copolymer is extruded into a molten sheet of film. The molten polyethylene is forced out of an extruder by conventional means such as using an extruding screw resulting in an almost water-like curtain of a molten polyethylene descending under the action of gravity as a smooth curtain constituting a molten sheet of film.

As used herein, unless otherwise differentiated, “polymer” includes copolymers and terpolymers, “polymerization” includes copolymerization and terpolymerization; “monomer” includes comonomer and termonomer.

The molten sheet of film is directed between the paper sheet and the foam sheet to form a three layer laminate of foam, polyethylene film and paper. The term “layer” in this context is understood to be interchangeable with terms such as layers, sheets or webs. The three layers of the foam, molten polyethylene film and paper come together at the entrance of a nip having a preset gap. The nip typically and preferably comprises large rollers set at a defined gap, such as two opposing rollers. The gap between the rollers defining the nip can be maintained by common means such as a piston, hydraulic piston, pneumatic piston, spring loaded arms, or turnscrew or the like attached to the axle of one or both rolls to exert pressure or bias the rolls one towards the other and optionally a détente used to maintain the desired separation between the rollers defining the minimum gap. It will be understood that the gap of the nip actually maintained will be a function of the pressure exerted on the roll or rolls and the rigidity of the laminate fed into the nip. The rolls for example can be polished steel. Preferably the nip is able to be chilled.

The nip could be formed from various alternative conventional means including without limitation two steel blocks spaced apart, a slot die, a roller and opposing blocks, opposing blocks, opposing belts, and the like. Optionally, a friction reducing coating can be employed. Any two surfaces that function to squeeze the laminate can be employed as the nip. Adjustability of the gap is desirable to enhance control.

Optionally, or alternatively, a third roller can be applied to the outer circumference of roll 4 or roll 5 to press or bias either of the rolls toward the other. In such an arrangement, the axle of roll 4 or 5 could be positioned moveable in a retaining channel.

The molten polyolefin is preferably low-density polyethylene (LDPE) or high density polyethylene (HDPE). The polyolefin can also be selected from linear low density polyethylene (LLDPE) or copolymers, oriented polypropylene (OPP), polypropylene copolymer, polybutylene and polybutylene copolymers. HDPE and LDPE are preferable materials, and LDPE preferred as the best mode.

Additives may be optionally included in the molted polyolefin extrudate to aid in the manufacturing process. These additives include, but are not limited to, any of the following exemplary additives: ethylene vinyl acetate, ethylene vinyl alcohol, plasticizers, fatty acid ester modifiers, fragrances, antioxidants, colorants, and the like.

The foam layer is selected as a low or high density polyethylene (HDPE or LDPE), linear low density polyethylene (LLDPE), homopolymer or copolymer oriented polypropylene and the like. A conventional blowing agent such as isobutane, methylene chloride, hexane, butane, carbon dioxide, ethane, propane, hydrofluorocarbons, or acetane is used to foam the material. Processes such as Ioka U.S. Pat. No. 4,435,344 relying on residual moisture in the paper layer can also be used as a blowing agent for the polyethylene foam. A pre-foamed low density polyethylene foam is preferred as the foam laminate.

The gases trapped within the film layer impart a high level of thermal insulation. An important aspect of the gas-containing foam layer is to impact resistance to energy transfer. The amount of trapped gas is variable. In the lamination process, retaining the caliper of the foam is important to preserve the foams' insulating ability.

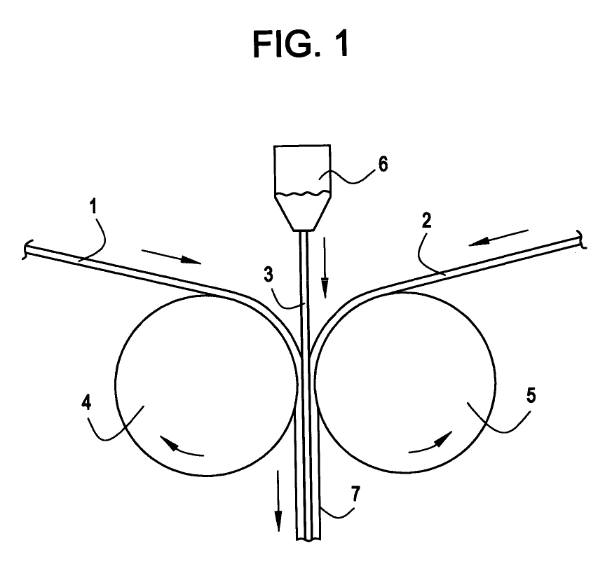

FIG. 1 is a cross-sectional view of an apparatus for manufacture of a laminate illustrating a method of the invention.

In FIG. 1 a molten polyolefin material preferably LDPE is shown being extruded into a molten sheet of film 3 from extruder 6. The molten LDPE is directed between paper sheet 1 and the top surface of foam sheet 2 to form a three layer laminate 7 at the point that the three materials converge at the nip having a preset gap defined by roll 4 and chill roll 5.

Rolls 4 and 5 preferably are metallic and roll 5 is preferably chilled. Heating can be considered if remelting of any of the layers is desired.

Rolls 4 and 5 press the three layers of paper 1, molten film 3 and foam 2 into adherent contact as the molten film solidifies to form a laminate of substantially uniform caliper exiting the nip. The nip exerts pressure on the substrates 1, 2 and 3 forcing them against one another and substantially fusing the three layers into a three layer laminate.

Preferably, the foam 2 is comprised of closed gas cells entrapped by a polymer matrix. As the foam is compressed, the cells will exhibit some level of resiliency. Preferably the cells are not ruptured so as not to degrade the foam caliper. Gentle pressure is preferable in the nip to achieve a substantially uniform caliper of the three layer laminate. The molten polymer layer is likely above the melt point of the foam, depending on materials selection. Care should be taken to not degrade the cell structure of the foam appreciably such as by employing chilling in one or both rolls 4 and 5. Chilling of the nip can be accomplished by conventional means.

Degrading the foam is undesirable since it would degrade the insulation value of the laminate. It is desirable to maintain as much of the foam caliper as possible, yet to even out the high points so as to achieve substantially uniform caliper. It should be understood substantially uniform caliper in this context does contemplate that there will be caliper variation particularly low points. The primary purpose of the nip is to at least flatten or even out the high points.

The preset gap, which could be a fixed gap, of the nip is set at a distance that is slightly less than the combined caliper of foam 2, molten film 3 and paper 1. For example, if the foam is 20 mils. thick, the paper 18 mils and the molten film 1 mil thick, the gap may be set at 36 mils. The skilled artisan will readily be able to ascertain the appropriate gap setting with a view that the foam is reversibly compressed while avoiding irreversible foam cell rupture or degradation.

The nip with pre-set gap helps to reduce caliper variation. The laminate exiting the nip is a laminate of substantially uniform and retained caliper. It should be understood that substantially uniform and retained caliper means that the high points are flattened or evened out. By retained caliper is meant that the foam in particular is not substantially degraded, that the foam cell structure is largely maintained.

In the above example the laminate layers have a combined thickness or caliper of 39 mils. The nip is set at 36 mils. The exiting laminate therefore has an exiting caliper which is substantially uniform and retained at around 36 mils. Preferably not more than 30% of the overall thickness is reduced, and more preferably reduced by not more than about 10%. In the above example, thickness loss is only about 8%. Minimizing any caliper loss, particularly of the foam, is very desirable and an aspect achievable by appropriate selection of the preset gap of the nip by “substantially uniform and retained” caliper it is intended that the high points are flattened or evened out and that foam cell structure degradation is minimized such that the overall thickness of the laminate is reduced by not more than 30% and more preferably reduced by not more than 10%, and most preferably that the exiting caliper approximates the entering caliper. Because of the compressibility of the foam, it is also contemplated that the exiting caliper of the laminate could exceed the preset gap of the nip since foam has aspects of memory due to resiliency. However the exiting laminate is more uniform and having a largely preserved caliper makes the material uniquely useable as a novel insulation material for insulated beverage and food containers.

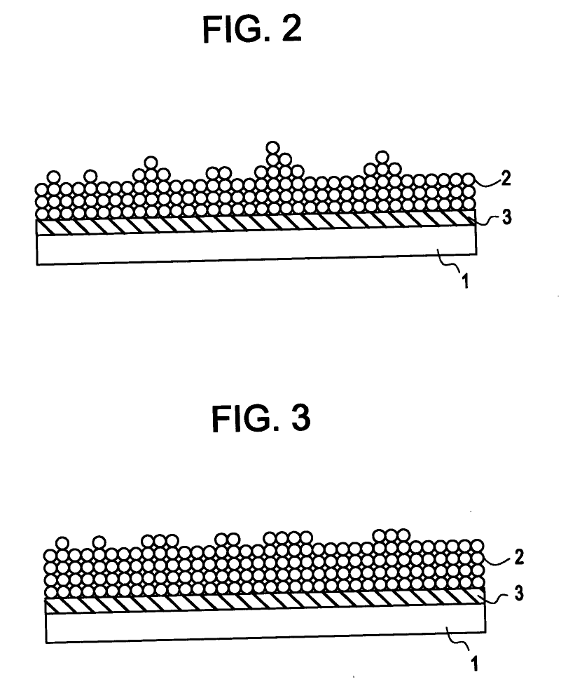

The foam 2 and to a lesser extent paper 1 have variation in caliper in both the machine and cross direction. As higher caliper sections move through the nip defined by rolls 4 and 5, the laminate is compressed. High caliper foam areas (FIG. 2) are forced into the molten polymer layer. A combination of some cell rupture and thermal degradation in the nip reduces the high caliper areas, evening out caliper variation forming a laminate of substantially uniform caliper (FIG. 3). The substrate processed through the nip has substantially uniform caliper understood to mean that the caliper of the foam is largely maintained but that caliper variation has been reduced as compared to the starting foam caliper.

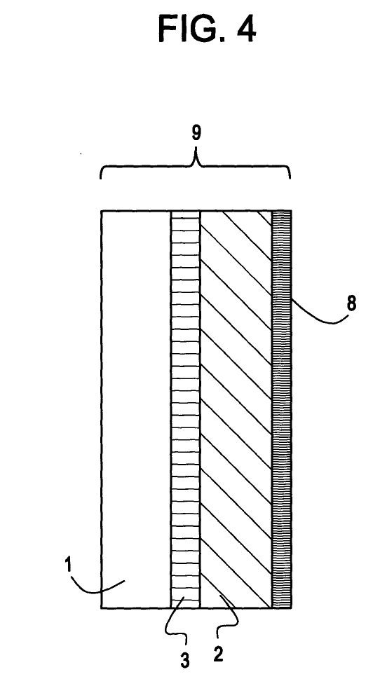

In FIG. 4 a four layer laminate is illustrated comprised of paper 1, polyolefin layer 3, foam 2 and polyolefin, preferably polyethylene layer 8. Layer 8 can be selected from materials such as low density polyethylene. Preferred would be a ¾ mil. LDPE. Substitution of an HDPE extrudate is optional as layer 8.

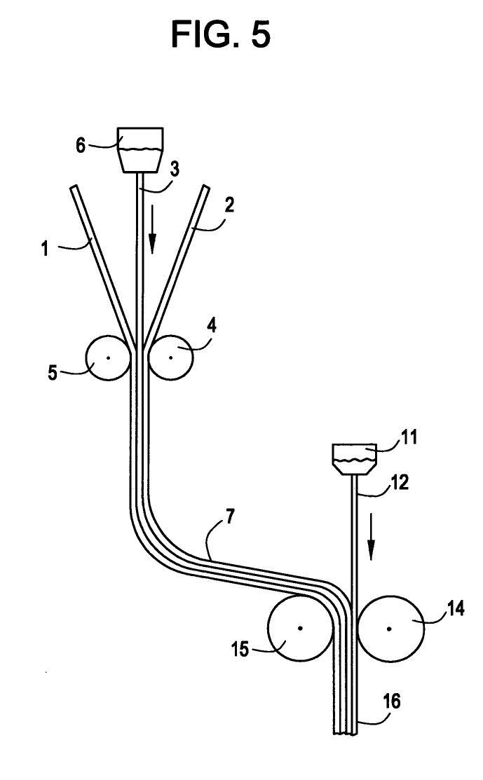

In yet another embodiment, optionally an additional polyolefin layer, similar or identical to layer 8 of FIG. 4 can also be extruded onto the external surface of paper 1. If the additional layer is low density polyethylene such as LDPE, LLDPE, HDPE or copolymer, a five layer laminate of PE film, paper, PE film, foam, PE film results. The method of manufacturing a foam layer laminate of FIG. 5 can readily be adapted to add an additional extruding station to add an additional extruding station to add an PE film layer onto the external surface of paper 1.

The skilled artisan will recognize that various constructs of adding additional extruders to form multi-layer variations are readily envisioned and possible according to the invention.

Layer 8 more preferably is a heat shrinkable polymeric material. Heat shrink polymer materials can include high density polyethylene (HDPE), low density polyethylene (LDPE), linear low density polyethylene (LLDPE), polyvinyl chloride (PVC), PTFE, FEP, PVDF, polyethyelene terephthalate, and the like. Heat shrink polymers can include ethylene-propylene copolymer, ethylene butene-1 homopolymers or copolymers (Foster U.S. Pat. No. 3,365,520); ethylene vinyl acetate copolymers blended with ethylene or propylene (Shirmer U.S. Pat. No. 3,754,063). Preferably the heat shrink polymer has a shrinkage of less than 40% and more preferably of 30% or less.

FIG. 5 is a cross-section view of an apparatus for manufacture of a laminate illustrating a method of the invention.

In FIG. 5 a molten polyolefin material, preferably LDPE is shown being extruded into a molten sheet of polymeric film 3 from extruder 6. An extruder screw, such as a single or tandem extruder, can be used to force molten LDPE from extruder 6 which is directed such as by gravity, between paper sheet 1 and the top surface of foam sheet 2 to form a three layer laminate 7. The laminate is formed when the three materials converge at the nip having a preset gap. The nip is shown defined by rolls 4 and 5 but could also be formed as a slit in a die or opposing stationary blocks, a block and a roll, or any other common means of defining a preset gap.

FIG. 5 depicts a second pair of rolls 14 and 15 and a second extruder 11. Molten polyolefin 12 from second extruder 11 is illustrated directed onto the opposite surface of foam layer 2 to form a four layer laminate 16.

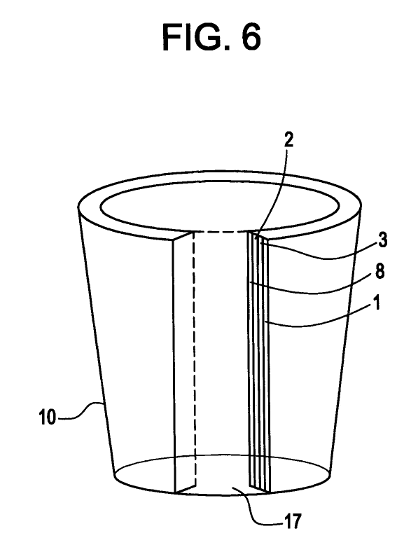

FIG. 6 illustrates a cup or sleeve made from the four layer laminate of the invention. The cut away view of the side wall shows a polyolefin, preferably polyethylene inner layer 8. Most preferably polyolefin layer 8 is a heat shrink polyethylene, and selected to be HDPE or LDPE. Foam layer 2 has polyolefin layer 3, preferably low density polyethylene adhered on the opposed side. Paper layer 1 forms the outside sidewall. A cup is formed if cup bottom 17 is included. A sleeve is optionally arrived at if the cup bottom 17 is omitted.

The principles, preferred embodiments, and modes of operations of the present invention have been described in the foregoing specification. The invention which is intended to be protected herein, however, is not to be construed as limited to the particular forms disclosed, since these are to be regarded as illustrative rather than restrictive variations and changes can be made by those skilled in the art without departing from the spirit and scope of the invention.

What is claimed is:

1. A method of producing an insulated container stock, comprising the steps of:
providing a layer of polymeric foam having a first surface and second surface;
providing a paper stock layer suitable for food or beverage stock;
extruding a molten polyolefin forming a molten sheet of film directed between the paper stock layer and a first surface of the foam layer to form an at least three layer laminate of foam, polyolefin film, and paper;
directing the at least three layer laminate into a nip having a preset gap; and,
pressing the layers of the at least three-layer laminate entering the nip into adherent contact as the molten film solidifies to form a laminate of substantially uniform and retained caliper exiting the nip.

2. A method of producing an insulated container stock according to claim 1 comprising the additional step of:
forming the at least three layer laminate into a container wall for surrounding an interior space.

3. A method of producing an insulated container stock according to claim 1, comprising the additional steps of:
forming the at least three layer laminate into a container wall for surrounding an interior space, and adding a bottom portion to form a cup.

4. A method of producing an insulated container stock according to claim 1, comprising the additional steps of:
extruding a molten polymer as a fourth layer forming a molten sheet of film directed onto a second surface of the foam of the three layer laminate to form a four layer laminate of film, foam, polyolefin film and paper;
directing the four layer laminate into an additional nip having a preset gap;
pressing the layers of the four layer laminate entering the nip into adherent contact as the molten film solidifies.

5. The method according to claim 4 wherein an additional layer of a polyethylene polymer is applied to the paper of the four layer laminate to form a five layer laminate.

6. A method of producing an insulated container stock according to claim 1, comprising the additional steps of:
extruding a heat shrinkable polymer as a fourth layer forming a molten sheet of film directed onto a second surface of the foam of the three layer laminate to form a four layer laminate of shrinkable film, foam, polyolefin film and paper;
directing the four layer laminate into an additional nip having a preset gap;
pressing the layers of the four layer laminate entering the nip into adherent contact as the shrinkable film solidifies.

7. A method of producing an insulated container stock according to claim 1, wherein the nip into which the three layer laminate is directed is comprised of two rolls.

8. A method of producing an insulated container stock according to claim 4, comprising the additional steps of:
forming the four layer laminate into a container wall for surrounding an interior space, and adding a bottom portion to form a cup.

9. A method of producing an insulated container stock according to claim 6, comprising the additional steps of:
forming the four layer laminate into a container wall for surrounding an interior space, and adding a bottom portion to form a cup.

10. A method of producing an insulated container stock according to claim 9, comprising the additional steps of:
heat treating the cup to shrink the fourth layer of shrinkable film of the four layer laminate formed into a container wall for surrounding an interior space.

11. A method of producing an insulated container stock according to claim 4, comprising the additional steps of:
chilling the nip into which the four layer laminate is directed.

12. A method of producing an insulated container stock according to claim 6, wherein the shrinkable polymer of the fourth layer is a polyethylene polymer or copolymer.

13. A method of producing an insulated container stock, comprising the steps of:
providing a layer of polymeric foam having a first surface and second surface
providing a paper stock layer suitable for cup stock
extruding a molten low density polyethylene polymer or copolymer forming a molten sheet of film directed between the paper sheet and a first surface of the foam layer to form a three layer laminate of foam, polyethylene film, and paper;
directing the three layer laminate into a nip having a preset gap;
pressing the layers of the three layer laminate entering the nip into adherent contact as the molten polyethylene film solidifies to form a laminate of substantially uniform and retained caliper exiting the nip;
extruding a shrinkable polymer as a fourth layer to form a molten layer of shrinkable film directed onto a second surface of the foam of the three layer laminate to form a four layer laminate of polyethylene film, foam, shrinkable film and paper;
directing the four layer laminate into an additional nip having a preset gap;
pressing the layers of the four layer laminate entering the nip into adherent contact as the shrinkable film solidifies; and,
forming the four layer laminate into a container wall for surrounding an interior space, and adding a bottom portion to form a cup.

14. A method of producing an insulated container stock, comprising the steps of:
providing a layer of polymeric foam having a first surface and second surface;
providing a paper stock layer suitable for cup stock;
extruding a molten low density polyethylene polymer or copolymer into a molten sheet of film directed between the paper stock layer and a first surface of the foam layer to form a three layer laminate of foam, polyethylene film, and paper;
directing the three layer laminate into a nip having a preset gap;
pressing the layers of the three layer laminate entering the nip into adherent contact as the molten polyethylene film solidifiers to form a laminate of substantially uniform and retained caliper exiting the nip;
extruding a molten heat shrinkable polymer as a fourth layer forming a molten sheet of shrinkable film directed onto a second surface of the foam of the three layer laminate to form a four layer laminate of shrinkable film, foam, polyethylene film and paper;
directing the four layer laminate into an additional nip having a preset gap;
pressing the layers of the four layer laminate entering the nip into adherent contact as the shrinkable film solidifies;
forming the four layer laminate into a container wall for surrounding an interior space;
adding a bottom portion engaging the container wall along a lower side portion thereof to form a cup; and,
heat treating the formed cup to shrink the fourth layer of the four layer laminate.

15. An insulated container produced by:
providing a layer of polymeric foam having a first surface and second surface;
providing a paper stock layer suitable for food or beverage stock;
extruding a molten polyolefin forming a molten sheet of film directed between the paper stock layer and a first surface of the foam layer to form an at least three layer laminate of foam, polyolefin film, and paper;
directing the at least three layer laminate into a nip having a preset gap; and,
pressing the layers of the at least three-layer laminate entering the nip into adherent contact as the molten film solidifies to form a laminate of substantially uniform and retained caliper exiting the nip;
forming the at least three layer laminate into a container wall for surrounding an interior space, adding a bottom portion engaging a lower portion of the container wall to form a container.

16. An insulated container stock material comprising:
a paper stock layer;
a foam layer disposed along an interior surface of the paper stock layer;
a first polymer film layer disposed between the paper stock layer and foam layer, wherein the polymer film layer is extruded as a molten film directed between the paper stock layer and the foam layer to form a three layer laminate of foam, polyethylene film and paper as the film solidifies;
a second polymer film layer extruded as a molten film directed onto the foam layer to form a four layer laminate as the polymer.

17. The insulated container according to claim 16, wherein the first and second polymer films are each independently selected from high density polyethylene, low density polyethylene, polyethylene copolymer, linear low density polyethylene, polypropylene, polypropylene copolymer, polybutylene and polybutylene copolymer.

18. An insulated container comprising:
a paper stock layer;
a foam layer disposed along an interior surface of the paper stock layer;
a first polymer film layer disposed between the paper stock layer and foam layer, wherein the polymer film layer is extruded as a molten film directed between the paper stock layer and the foam layer to form a three layer laminate of foam, polymer film and paper as the film solidifies;
a polymer shrink film layer having a percent shrink of 30% or less extruded as a molten film directed onto the foam layer to form a four layer laminate as the polymer shrink film solidifies, and the four layer laminate formed into a container wall for surrounding an interior space,
a bottom portion engaging the container wall along a lower side portion thereof to form a container, and the formed container being heat treated to shrink the fourth layer of the four layer laminate.
